(19) United States
(12) Patent Application Publication
(10) Pub. No.: US 2010/0089275 A1
(43) Pub. Date: Apr. 15, 2010

(54) MASS TRANSIT SYSTEM

(76) Inventor: Darryl Lane, Toronto (CA)

Correspondence Address: HERMAN & MILLMAN, 55 University Ave, Suite M002, Box 47, TORONTO, ON, M5H 3L5, CA

(21) Appl. No.: 12/248,120

(22) Filed: Oct. 9, 2008

(51) Int. Cl. E01B 25/00; B60L 5/38

(52) U.S. Cl. 104/124; 104/125; 191/22 R

(57) ABSTRACT

In a particular embodiment, the invention is directed to a mass transit system that includes a vehicle, a track support, a first vehicle support flange and a second vehicle support flange. The vehicle has a center of mass. The track support is cylindrical and hollow. The first vehicle support flange is connected to the track support at a first elevation. The second vehicle support flange is connected to the track support at a second elevation that is different than the first elevation. The first and second vehicle support flanges are configured to support the vehicle on one side of the center of mass of the vehicle.

### FIELD OF THE INVENTION

The present invention relates to mass transit systems and in particular to an elevated mass transit system.

### BACKGROUND OF THE INVENTION

Mass transit systems have the promise of transporting relatively large numbers of passengers at relatively low cost and with relatively high efficiency in terms of per passenger space requirements and energy consumption. However, many problems exist with current and proposed systems. For example, for underground systems, ie. subway systems, the cost for construction is prohibitively high. In addition, a disabled vehicle that is between stations is often relatively inaccessible, and offers passengers stranded thereon few options in terms of evacuation.

Dedicated streetcar and bus right-of-ways and commuter train systems are relatively inexpensive to construct, but possess a relatively large footprint in terms of consumed real estate, and can interfere with vehicular traffic depending on their routing.

Some elevated systems have been implemented or proposed in an attempt to solve problems with ground-based or underground-based systems. However, some elevated systems still possess relatively large footprints, and the track system for some elevated systems may create an undesirably large visual obstruction to the sky for pedestrian and vehicular traffic nearby.

It would therefore be advantageous to provide a mass transit system that addresses one or more of these shortcomings.

### SUMMARY OF THE INVENTION

In a first aspect, the invention is directed to a guideway for a vehicle. The vehicle has a center of mass. The guideway includes a track support, a first vehicle support flange and a second vehicle support flange. The track support is cylindrical and hollow. The first vehicle support flange is connected to the track support at a first elevation. The second vehicle support flange is connected to the track support at a second elevation that is different than the first elevation. The first and second vehicle support flanges are configured to support the vehicle on one side of the center of mass, eg. cantilevered off the side of the guideway.

In a second aspect, the invention is directed to a guideway for a vehicle. The vehicle has a center of mass. The guideway includes a track support, a first vehicle support flange and a second vehicle support flange. The track support is cylindrical and hollow. The first vehicle support flange is connected to the track support. The second vehicle support flange is connected to the track support. The first and second vehicle support flanges are configured to support the vehicle on one side of the center of mass.

In a third aspect, the invention is directed to a mass transit system that includes a vehicle, a track support, a first vehicle support flange and a second vehicle support flange. The vehicle has a center of mass. The track support is cylindrical and hollow. The first vehicle support flange is connected to the track support at a first elevation. The second vehicle support flange is connected to the track support at a second elevation that is different than the first elevation. The first and second vehicle support flanges are configured to support the vehicle on one side of the center of mass.

In a fourth aspect, the invention is directed to a mass transit system that includes a guideway that permits the operation of both magnetically levitated and wheeled vehicles.

In a fifth aspect, the invention is directed to a mass transit system that includes a guideway, a first vehicle that is movable on one side of the guideway, a second vehicle that is movable on another side of the guideway and a service vehicle that is movable on top of the guideway. The service vehicle may be a mobile crane and may include at least one gripper arm for gripping a portion of the guideway to permit the mobile crane to pick up a vehicle from the guideway.

In a sixth aspect, the invention is directed to a guideway for a vehicle, including a track support that is cylindrical and hollow and a plurality of vehicle support flanges that extend radially from the track support. Optionally, flange support members may be provided which connect to and support the vehicle support flanges. As a further option, the flange support members, the vehicle support flanges and the track support generally form triangles in cross-section. As a yet further option, a spacer may be provided between the flange support members and the track support. The spacer may cooperate with the flange support members and the track support to define a recess which is sheltered from the elements and which can house a power transfer surface to transfer electrical power from a source inside the track support to the vehicle.

### BRIEF DESCRIPTION OF THE DRAWINGS

The present invention will now be described by way of example only with reference to the attached drawings, in which:

FIG. 1 is a sectional elevation view of a portion of a mass transit system in accordance with an embodiment of the present invention, including a guideway and two vehicles;

FIG. 1a is a magnified sectional view of the guideway and a portion of one of the vehicles;

FIG. 1b is a sectional view of the guideway shown in FIGS. 1 and 1a, with a wheeled vehicle thereon;

FIG. 2 is a side view of the guideway and two three-compartment vehicles, illustrating the operation of an evacuation slide from one of the vehicles;

FIG. 3 is a floor plan view of two vehicles and a vehicle access platform that may be part of the mass transit system;

FIG. 4 is a sectional view of a straight section of the guideway;

FIG. 5 is a sectional view of a banked portion of the guideway, to illustrate that the guideway can be banked along curved sections;

FIG. 6 is a perspective view of the guideway;

FIG. 7 is a perspective view illustrating the mating between two sections of the guideway;

FIGS. 8a and 8b are plan views illustrating two positions for a linear switch that may be part of the guideway to permit a branching in the guideway;

FIG. 9 is a magnified plan view of a portion of the linear switch shown in FIGS. 8a and 8b;

FIG. 9a is an elevation view of a stationary section of guideway immediately adjacent the linear switch;

FIG. 9b is a sectional side view illustrating the mating of a section of guideway in the linear switch with the stationary section of guideway shown in FIG. 9a;

FIG. 9c is an elevation view of another stationary section of guideway that is adjacent another portion of the linear switch;

FIGS. 10a, 10b and 10c are plan views of a turntable switch that may be part of the guideway for permitting access between any two of three intersecting branches of the guideway, illustrating the turntable switch in three possible positions;

FIG. 11 is a magnified plan view of the turntable switch that is shown in FIGS. 10a, 10b and 10c;

FIG. 12 is a plan view of a transit station that may be provided under the turntable switch shown in FIGS. 10a, 10b, 10c and 11;

FIG. 13 is a magnified floor plan view of one of a four-compartment vehicle;

FIG. 13a is a plan view of the roof of the vehicle shown in FIG. 13, showing single upper wheels;

FIG. 13b is a plan view of the roof of the vehicle shown in FIG. 13, showing double upper wheels;

FIG. 14 is a sectional elevation view of one of the vehicles;

FIG. 14a is a front elevation view of one of the vehicles;

FIG. 15 is a front elevation view of one of the vehicles being serviced by a mobile crane that may be part of the mass transit system;

FIG. 16 is a side elevation view of one of the vehicles being serviced by the mobile crane; and

FIG. 17 is a plan view of the turntable switch shown in FIGS. 10a, 10b, 10c and 11 illustrating the storage of and access to the mobile crane, and spare vehicle storage;

FIG. 18a is an elevation view of a free body diagram of the guideway;

FIG. 18b is a perspective view of a free body diagram of the guideway;

FIG. 18c is an elevation view of a free body diagram of the vehicle; and

FIG. 19 is a plan view of vehicles passing each other on a curved section of the guideway.

### DETAILED DESCRIPTION OF THE INVENTION

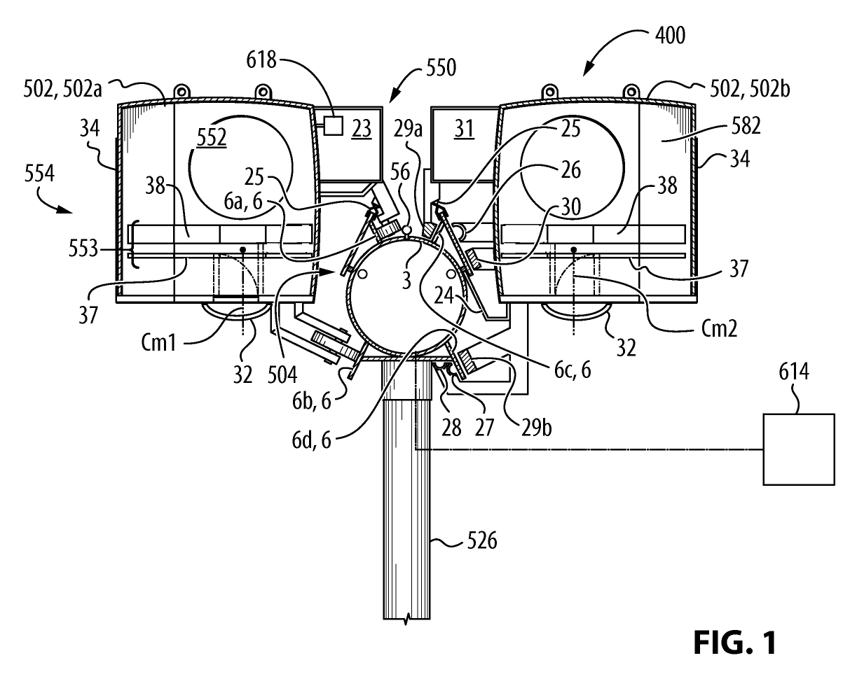

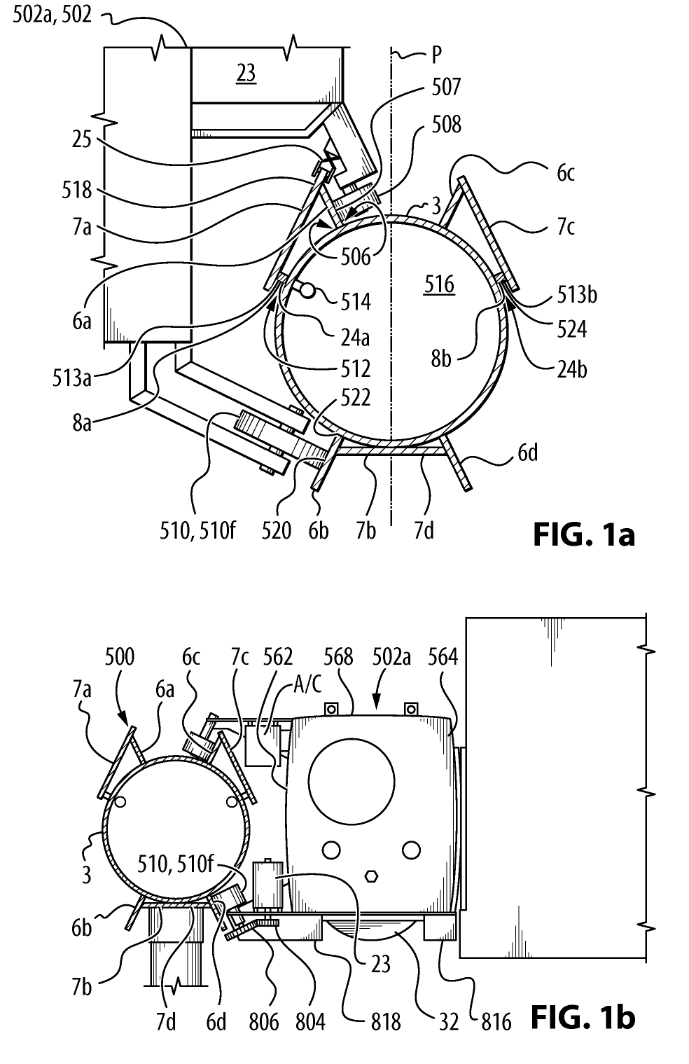

Reference is made to FIG. 1, which shows a mass transit system 400 in accordance with an embodiment of the present invention. The mass transit system 400 includes a guideway 500 and a plurality of vehicles 502, including a first vehicle 502a and a second vehicle 502b. The guideway 500 includes a track support 3 that is cylindrical and hollow. Connected to the track support 3 are a plurality of vehicle support flanges 6 including a first vehicle support flange 6a, a second vehicle support flange 6b, a third vehicle support flange 6c and a fourth vehicle support flange 6d. The first and second vehicle support flanges 6a and 6b are configured to support the first vehicle 502a on a first side 504 of the track support.

The first and second vehicle support flanges 6a and 6b are positioned at first and second elevations and support the vehicle 502a on one side of the center of mass, shown at Cm1, of the vehicle 502a. By supporting the vehicle 502a on one side of its center of mass Cm1, the guideway 500 has a reduced overall width compared with a guideway of the prior art that supports a vehicle on both sides of the center of mass of the vehicle. By having a reduced width, the footprint of the guideway 500 may be smaller than with some prior art guideways. In embodiments wherein the guideway 500 is elevated, as shown in FIG. 1, the degree of visual obstruction to people underneath or otherwise proximate the guideway 500 is also reduced.

Referring to FIG. 1a, the first vehicle support flange 6a has a first vehicle support surface 507 where it supports the vehicle 502a. For example, in an embodiment wherein the vehicle 502a rolls on wheels, shown at 508 and 510, the first vehicle support surface 507 is the surface on which the first vehicle wheel 508 rolls during use. The wheels 508 and 510 may be provided with tires to reduce noise that would otherwise be present if there were metal-to-metal contact between the wheels and the guideway 500.

The first vehicle support flange 6a may be connected to the track support 3 by any suitable means. For example, a first edge 506 of the first vehicle support flange 6a may be welded to the track support 3. The first vehicle support flange 6a may extend generally radially outwardly from the track support 3. The first vehicle support flange 6a thus acts as a strengthening rib to assist the track support 3 in resisting bending loads imposed thereon by the vehicles 502.

Additionally, a first flange support member 7a may be provided which supports the first vehicle support flange 6a at a point spaced from the first edge 506. The first flange support member 7a may be connected to the first vehicle support flange 6a by any suitable means, such as a weld.

The first flange support member 7a may be connected to the track support 3 through a spacer 8a. The spacer 8a extends outwards from the track support 3 and has a relatively low profile. For example, the spacer 8a may have a substantially square cross-sectional shape. In this way, the cross-sectional shape formed by the first flange support member 7a, the first vehicle support flange 6a, and the associated portion of the track support 3 may be substantially triangular and may therefore be particularly suited to resist deformation while supporting the vehicle 502a. Had the spacer 8a extended significantly farther out from the track support 3 then the aforementioned cross-sectional shape would be less triangular and more like a four-sided polygon, which has a reduced level of resistance to deformation than a triangle.

The first flange support member 7a and the triangular shaped structure formed by the first flange support member 7a, the first vehicle support flange 6a and the associated portion of the track support 3 provide the track support 3 with additional resistance to bending forces imposed thereon by the vehicles 502.

A portion of the first flange support member 7a may extend past the connection with the spacer 8a so that a downwardly-facing recess 512 is formed between the first flange support member 7a, the spacer 8a and the track support 3. A power transfer surface 513a may be provided in the recess 512, which permits power to be transferred to the vehicle 502a from a conduit 514 contained in the interior 516 of the track support 3. The power transfer surface 513a may be on the spacer 8a, or it may be on some other surface, such as on the outer surface in the recess 512, or such as the outer surface of the track support 3. By providing the power transfer surface 513a in the recess 512, it is protected from rain, snow and the like. An additional function for the lower lip of the first flange support member 7a is described below.

A portion of the first flange support member 7a may extend upwards past the connection with the first vehicle support flange 6a. In this way, the upwardly extending portion, shown at 518, acts as a curb which may cooperate with the first vehicle wheel 508 to inhibit the vehicle 502a from slipping off of the first vehicle support flange 6a.

The second vehicle support flange 6b has a second vehicle support surface 520 where it supports the second vehicle wheel 510. The second vehicle support flange 6b may be connected to the track support 3 by any suitable means. For example, a first edge 522 of the second vehicle support flange 6b may be welded to the track support 3. The second vehicle support flange 6b may extend generally radially outwardly from the track support 3. The second vehicle support flange 6b thus acts as a strengthening rib to assist the track support 3 in resisting bending loads imposed thereon by the vehicles 502.

As a result of the orientations of the first and second vehicle support flanges 6a and 6b, the support flanges 6a and 6b support the vehicle 502 in a cantilevered state off the side of the guideway 500.

Additionally, a second flange support member 7b may be provided which supports the second vehicle support flange 6b at a point spaced from the first edge 520. The second flange support member 7b may be connected to the second vehicle support flange 6b by any suitable means, such as a weld.

The second flange support member 7b may be directly connected to the track support 3. In this way, the cross-sectional shape formed by the second flange support member 7b, the second vehicle support flange 6b, and the associated portion of the track support 3 may be substantially triangular and may therefore be particularly suited to resist deformation while supporting the vehicle 502a.

The second flange support member 7b and the triangular shaped structure formed by the second flange support member 7b, the second vehicle support flange 6b and the associated portion of the track support 3 provide the track support 3 with additional resistance to bending forces imposed thereon by the vehicle 502a.

The vehicle 502a imposes both a bending load and a torsional load on the guideway 500 (in addition to other forces), through the first and second vehicle support flanges 6a and 6b. It will be noted that the vehicle wheels 508 and 510 engage the first and second vehicle support flanges 6a and 6b proximate the outer surface of the track support 3 relative to vehicles in some other proposed transportations systems, thereby keeping the moment exerted on the track support 3 by the vehicle 502a relatively small.

It will be noted that the vehicle 502a and the guideway 500 are configured so that the center of mass Cm1 of the vehicle 502a is positioned proximate the outer surface of the track support 3, relative to vehicles in some other proposed transportations systems, thereby keeping the moment exerted on the track support 3 by the vehicle 502a relatively small.

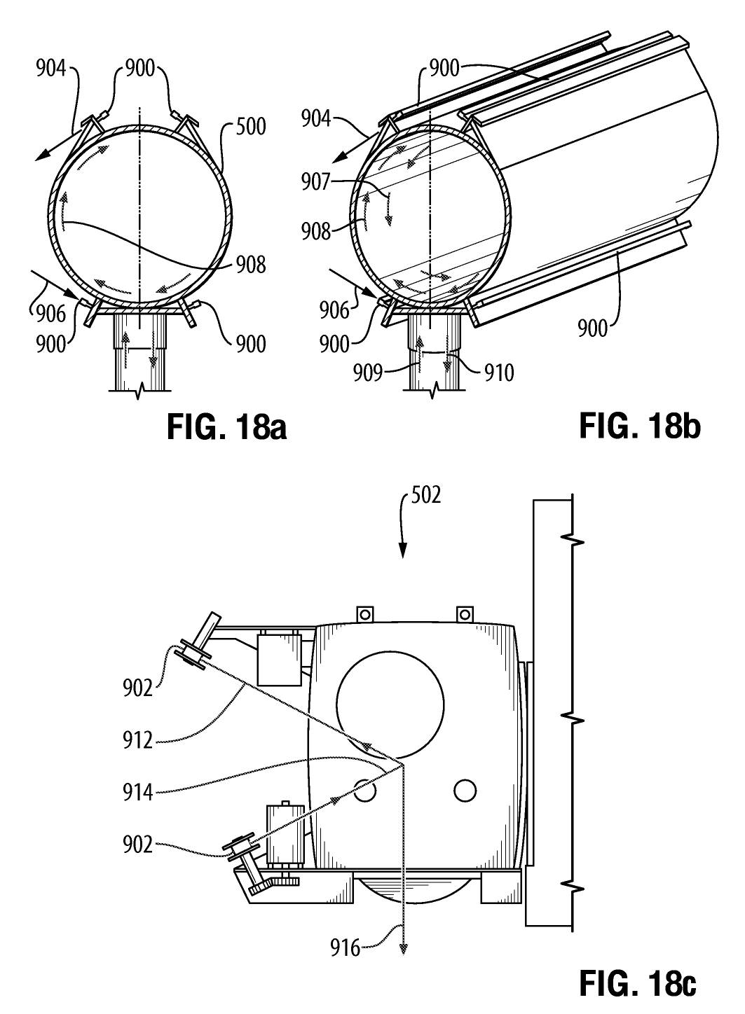

Referring to FIGS. 18a and 18b, by configuring the track support 3 as a cylindrical member, and particularly a hollow cylindrical member it is particularly suited to support torsional loads imposed thereon by the vehicles 502 being cantilevered on each side thereof, while itself having a relatively low weight.

The guideway 500 may further include a third vehicle support flange 6c and a fourth vehicle support flange 6d which are positioned at third and fourth elevations respectively and which are configured for supporting the vehicle 502b. The third and fourth vehicle support flanges 6c and 6d may be supported by third and fourth flange support members 7c and 7d respectively and may be similar to the first and second vehicle support flanges 6a and 6b respectively. A spacer 8b may be provided between the third flange support member 7c and the track support 3, such that a recess 524 may be formed in which there may be a power transfer surface 513b. The first, second, third and fourth vehicle support flanges 6a, 6b, 6c and 6d, the first, second third and fourth flange support members 7a, 7b, 7c and 7d and the spacers 8a and 8b may all be symmetrical about a vertical plane P that bisects the track support. Thus, the guideway 500 may be configured to support vehicles 502 on either side. This further reduces the overall footprint of the mass transit system 400 relative to some mass transit systems of the prior art, which require separate guideways or double-width guideways for supporting vehicles traveling in two directions. The fourth flange support member 7d may be integral with the second flange support member 7b.

It will be understood that the angles at which the first, second, third and fourth vehicle support flanges 6a, 6b, 6c and 6d are positioned about the track support 3 may be any suitable angle, the principle being that the tangential (torque) loads, shown at 912 and 914) exerted on the vehicle 502 by the cylindrical track support 3 intersect at or near the vector of the force of gravity which passes through the centre of mass CM1 as illustrated in FIG. 18c.

In the exemplary embodiment shown in FIGS. 18a and 18b, the guideway 500 is provided with tracks 900 to support a vehicle 500 (FIG. 18c) with flanged wheels 902. The forces imposed by the vehicle 502 (FIG. 18c) on the guideway 500 are shown at 904 and 906 in FIGS. 18a and 18b. The forces 904 and 906 result in a torque 907 being applied to a portion of the guideway 500 in the vicinity of the wheels 902. A reaction torque 908 is applied to that portion of the guideway 500 by the adjacent portions of the guideway 500 (one of which is shown in FIG. 18b), and by the column 1. Forces exerted on the guideway 500 from column 1 are shown in simplified form as force 909 and 910. The forces 909 and 910 simultaneously exert some of the reaction torque and support the guideway 500 against the vertical load imposed thereon by the vehicle 502.

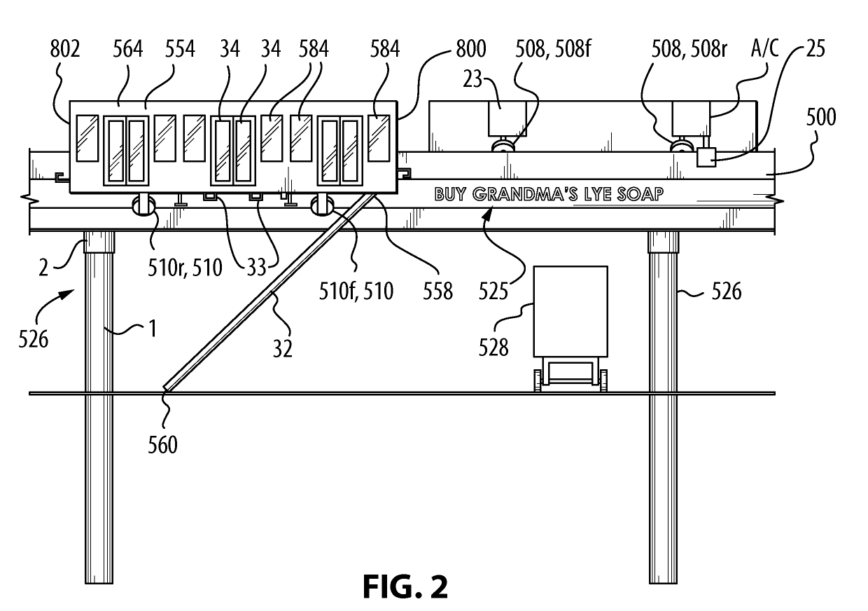

The track support 3 and any other portion of the guideway 500 may be used for receiving advertising (eg. painted advertising) and the like, an example of which is shown at 525 in FIG. 2. In this way, the owner of the mass transit system 400 can sell advertising space on the guideway 500 to assist in paying for the mass transit system 400 and for its operation.

In situations where a long portion of the guideway 500 is unsupported (eg. where it would pass over a roadway), the guideway 500 may be reinforced by some suitable means, such as by an I-beam welded in the interior 516 of the track support 3 or along the bottom of the track support 3.

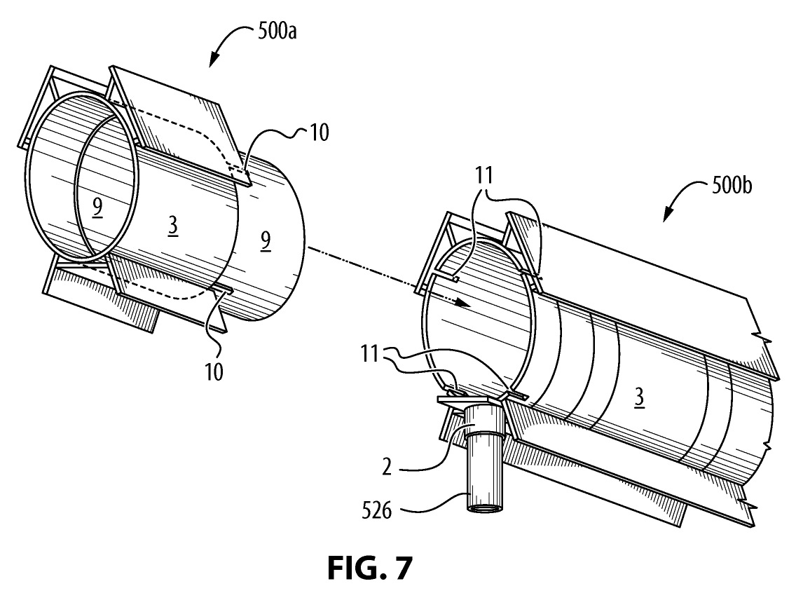

As shown in FIG. 7, to accommodate thermal expansion of the guideway 500 finger joints made up of fingers 10 and slots 11 may be provided in mating sections 500a and 500b. For example, the fingers 10 may be provided on the track support 3 from the guideway section 500a and the slots 11 may be provided on the track support 3 on the guideway section 500b. Additionally, a hollow dowel member 9 may be fixedly connected to one of the guideway sections 500a or 500b, eg. by welding. The other of the guideway sections 500a or 500b would slide on the dowel member 9 so as to keep the guideway sections 500a and 500b axially aligned with each other. As a result of using plate metal and cylindrical tube sections to construct the guideway 500, the guideway 500 may be constructed relatively inexpensively easily and off site in a quality-controlled environment.

Because of the cylindrical shape of the track support, the guideway 500 may easily be configured to provide superelevation, (ie. banking), to facilitate cornering of the vehicles 502, as shown in FIG. 5.

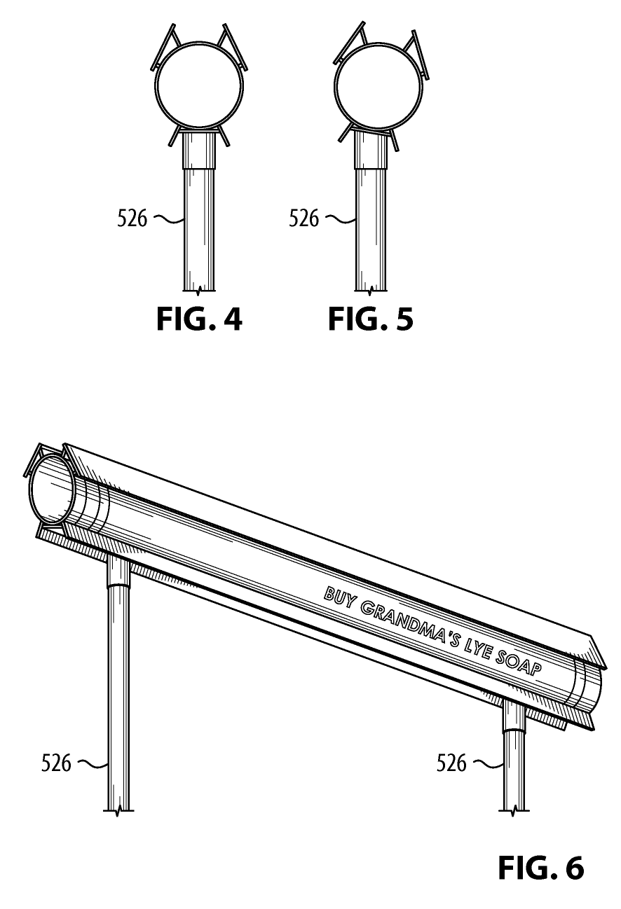

As shown in FIGS. 1, 2, 4 and 5, the guideway 500 may be elevated above ground level so as to reduce the amount of land required for it. As shown a column 526 that is of sufficient height to permit road traffic 528 (FIG. 2) to pass underneath the vehicles 502 and guideway 500 may be provided to support the guideway 500. The column 526 may be made up of a primary column section 1, which extends upwards from the ground and which may be an extension of a caisson foundation for supporting the mass transit system 400. A sleeve 2 which slidably fits over the primary column section 1 may be welded to the flange support members 7a and 7b on the bottom of the guideway 500. The guideway 500 is installed by raising it up and lowering it onto the primary column section 1 such that the sleeve 2 slides over the primary column section 1. At this point the guideway 500 can be adjusted to a precise desired height, and a weld can be applied between the sleeve 2 and the primary column section 1. Thus, by providing the sleeve 2 and the primary column section 1, precisely height adjustment of the guideway 500 is possible. It is alternatively possible to use any other form of column to elevate the guideway 500 as desired.

The guideway 500 may have a relatively small width, such as, for example, approximately 5 feet. The column 528 may have an even smaller width. As a result, it may be possible to position the guideway 500 along the median between two sides of an existing street or highway, so that at least some portions of the length of the guideway 500 would not need to occupy any new land. This is particularly advantageous in some urban areas where land is at a premium and where securing land for such a project could be objected to by segments of the local population.

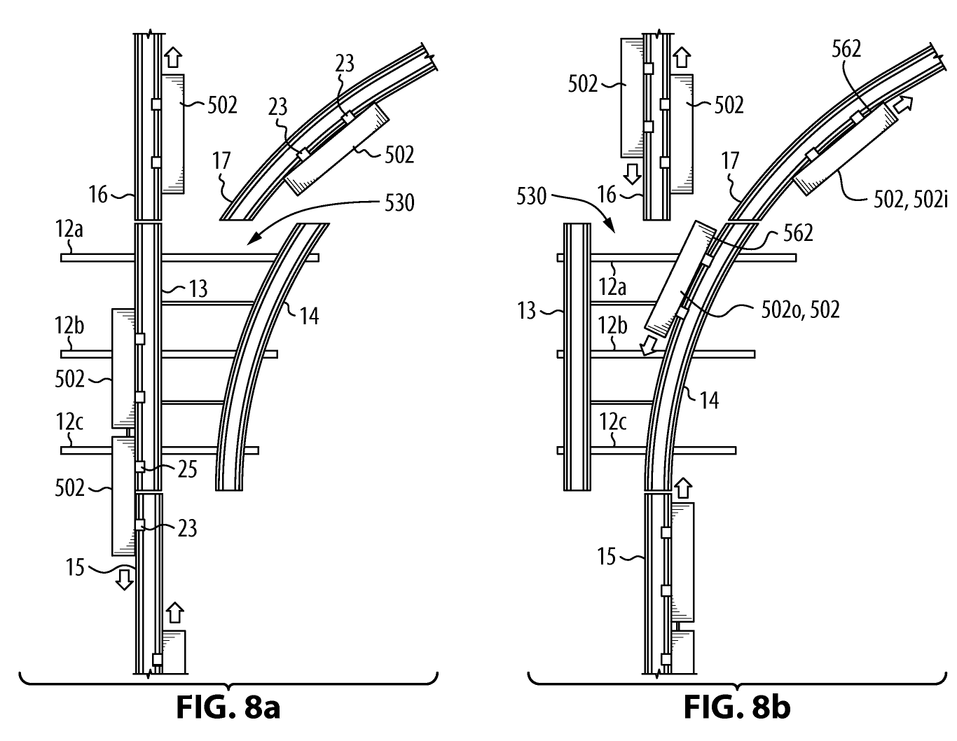

The guideway 500 may be relatively easily provided in straight or curved sections. Additionally, referring to FIGS. 8a and 8b, a switch 530 may be provided to permit a vehicle 502 traveling on a first section 15 of guideway 500 to selectively travel on either of two sections of guideway 500, shown at 16 and 17. Also, the switch 530 permits vehicles 502 traveling on either of the sections 16 or 17 to travel on the section 15. Thus, the switch 530 permits access to and from sections of guideway without requiring duplicate track to be erected.

The switch 530 may be a linear switch, and may include a first guideway switch section 13, a second guideway switch section 14 and a set of tracks 12a, 12b and 12c on which the first and second guideway switch sections 13 and 14 ride. The tracks 12a, 12b and 12c may be elevated on columns (not shown). Motive means, such as one or more motors may move the first and second guideway switch sections 13 between a first position, shown in FIG. 8a and a second position, shown in FIG. 8b. The first and second switch sections 13 and 14 may be connected together for common movement and may ride on the tracks 12a, 12b and 12c.

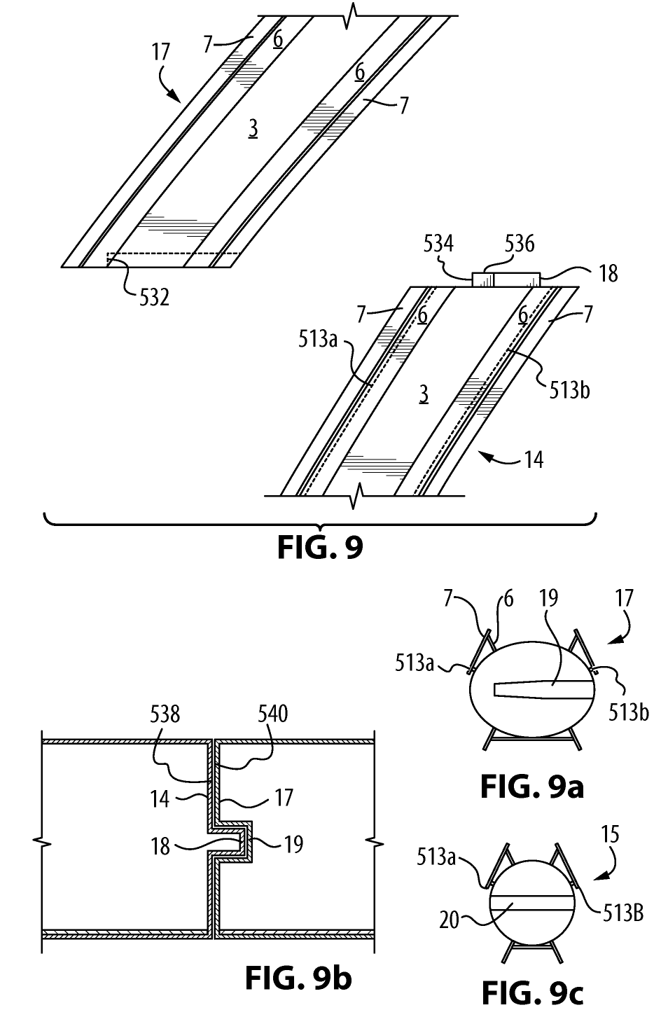

Referring to FIG. 9, the switch section 14 may be provided with a key 18, and the guideway section 17 may be provided with a slot 19 for receiving the key 18. The key 18 and the slot 19 serve to vertically align the switch section 14 with the guideway section 17 when the two sections 14 and 17 are mated together.

The slot 19 may terminate at an end wall 532, which cooperates with an end face 534 of the key 18 to fix the position of the switch section 14 with the guideway section 17 when the two sections 14 and 17 are mated together.

The key 18 includes a lead-in portion 536 that is tapered to facilitate entry of the key 18 into the slot 19. The slot, 19, as shown in FIG. 9a, also tapers proximate its closed end, to provide a snug fit with the lead-in portion 536 of the key 18, thereby more precisely aligning the switch section 14 with the guideway section 17. The slot 19 may be defined in an end wall 538 (FIG. 9b) on the guideway section 17, and the key 18 may be provided on an end wall 540 on the switch section 14.

The joint between the switch section 13 and the guideway section 16 may be similar to the joint between the switch section 14 and the guideway section 17, except that the switch section 13 would have a key that slides into a slot from the left in the view shown in FIG. 8, instead of sliding in from the right. The joints between the switch sections 13 and 14 and the guideway section 15 may be similar to the joint between the switch section 14 and the guideway section 17, except that the slot 20 (FIG. 9c) provided in the guideway 15 may be open ended at both ends, to permit the sliding into place of the switch section 14 from the right or the switch section 13 from the left in the view shown in FIG. 8.

It is alternatively possible to provide the keys on one or more of the stationary guideway sections 15, 16 and 17 and to provide slots on one or more of the switch sections 13 and 14.

Power transfer surfaces 513a and 513b are provided on the switch section 14 (FIG. 9) and on the switch section 13 (not shown in FIG. 9), so that power to the vehicles 502 may be provided even when the vehicles 502 are traveling on a switch section 13 or 14 and adjacent sections of guideway sections 15, 16 and 17. The mass transit system 400 may be configured so that power to the power transfer surfaces 513a and 513b on the switch sections 13 and 14 is only available if the active switch section 13 or 14 is suitably aligned with the guideway sections 17 and 15, or 16 and 15.

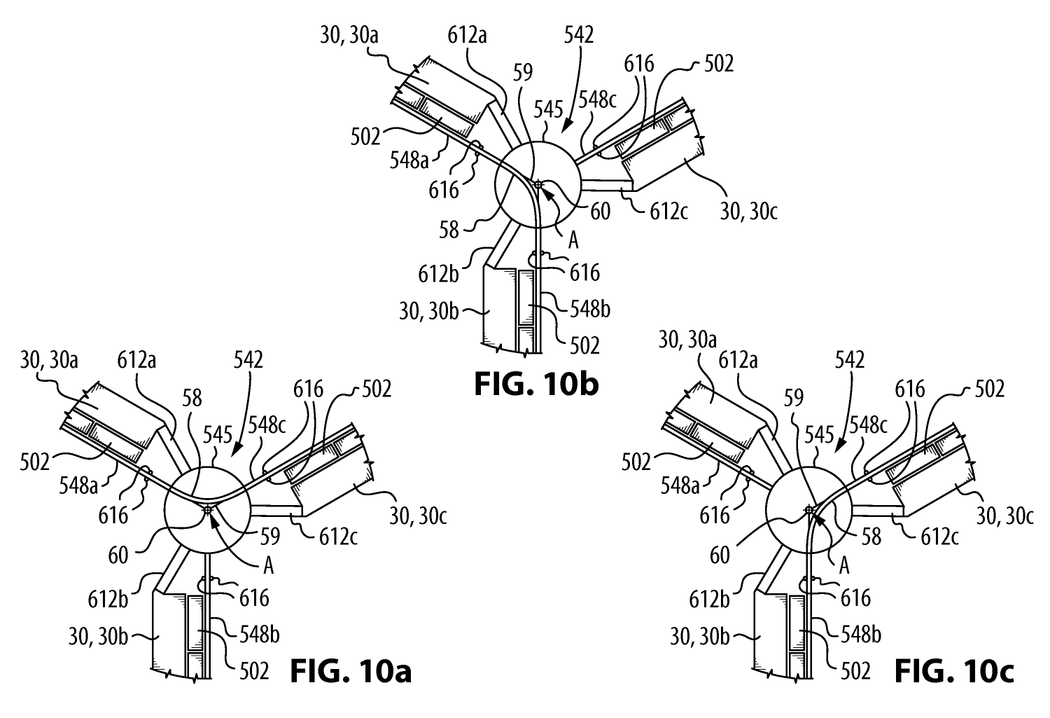

Referring to FIGS. 10a, 10b and 10c, an alternative switch 542 may be provided. The switch 542 is a turntable switch, which includes a switch section 58 that is rotatable about an axis A. The switch section 58 can be rotated to connected any two of the three guideway sections 548a, 548b and 548c shown. Thus, the switch 542 may be referred to as a three-way switch.

Referring to FIG. 11, the turntable switch 542 is shown in more detail. The turntable switch 542 includes a support platform 545 on which there is a track 62. A frame 59 rotatably connects the switch section 58 to the axis of rotation A. The switch section 58 and frame 59 are supported on boogies 61 that ride on the track 62. Any suitable means may be provided for driving the rotation of the switch section 58 about the axis A. For example, a motor may be provided under the support platform 545 that is operative to cause the rotation of a shaft 60 that is positioned on the axis A and that is part of the frame 59, or one or both of the boogies 61 may be motorized.

While not shown in the figures, there are power transfer surfaces 513a and 513b on the switch section 58 which are positioned so that power to the vehicles 502 may be provided even when the vehicles 502 are traveling on the switch section 58. The mass transit system 400 may be configured so that power to the power transfer surfaces 513a and 513b on the switch section 58 and to adjacent sections of guideways 548a, 548b and 548c is only available if the switch section 58 is suitably aligned with the guideway sections 548a, 548b or 548c.

Reference is made to FIG. 1. The vehicle 502a may be a wheeled vehicle, as shown. The vehicle 502a includes a motor 23, which may be positioned at the inboard side, shown at 550. In this way, the center of mass Cm1 of the vehicle 502a is positioned closer to the inboard side 550 of the vehicle 502a, and therefore closer to the guideway 500. The motor 23 may be any suitable type of motor, such as an electric motor, or a gasoline driven motor. Additionally, other elements such as the air conditioning and/or heating apparatus shown at 31 in FIG. 1 may be provided and may be positioned at the other upper wheel support or aft of the motor 23 but may be in a similarly inboard position so as to keep the center of mass Cm1 closer to the inboard side 550 and therefore closer to the guideway 500.

The vehicle 502a includes a passenger compartment 552 in which there may be seats 553, each with a seat portion 37 and a backrest 38. Sliding doors 34 are provided on the outboard side, shown at 554, of the vehicle 502a.

The seats 553 may be organized into rows 555, which are themselves arranged to form passenger cells 556. A passenger cell 556 comprises two rows 555 of seats 552 which face each other.

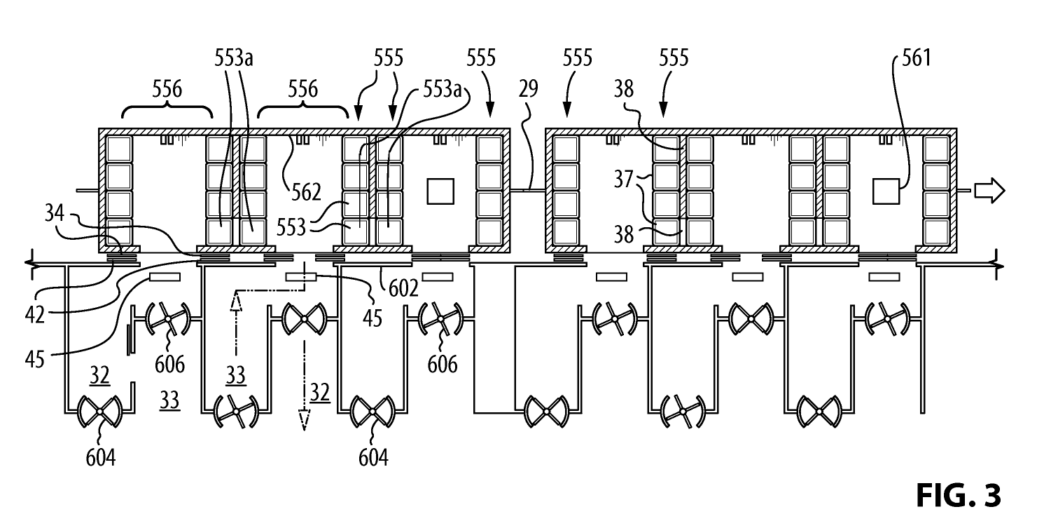

Referring to FIG. 3, the vehicle 502a may be relatively narrow (four seats 553 wide) to keep the center of mass Cm1 close to the guideway 500, with no permanent passageway between adjacent cells 556 of seats 553. Sliding doors 34 may be provided for each cell 556 of seats 553.

The vehicle 502a may be provided with an evacuation slide 32 that permits occupants to abandon the vehicle 502a and get to ground level if necessary. The evacuation slide 32 is hingedly connected to the underside of the vehicle 502a at one end, shown at 558 in FIG. 2, and has a free end 560 that drops down from the underside of the vehicle 502a to ground level. Preferably, the evacuation slide 32 is mounted so that the free end 560 is mounted rearwardly of the connected end 558. As a result, if the evacuation slide 32 were to be deployed while the vehicle 502a is moving forward, the free end 560 would drag on the ground instead of potentially digging in and causing damage to the slide 32 and/or the rest of the vehicle 502a. The slide 32 may have any suitable shape, such as an arcuate shape (similar to a stick of celery) for simplicity of manufacture and inherent strength, and may be made from any suitable material, such as a polymeric material.

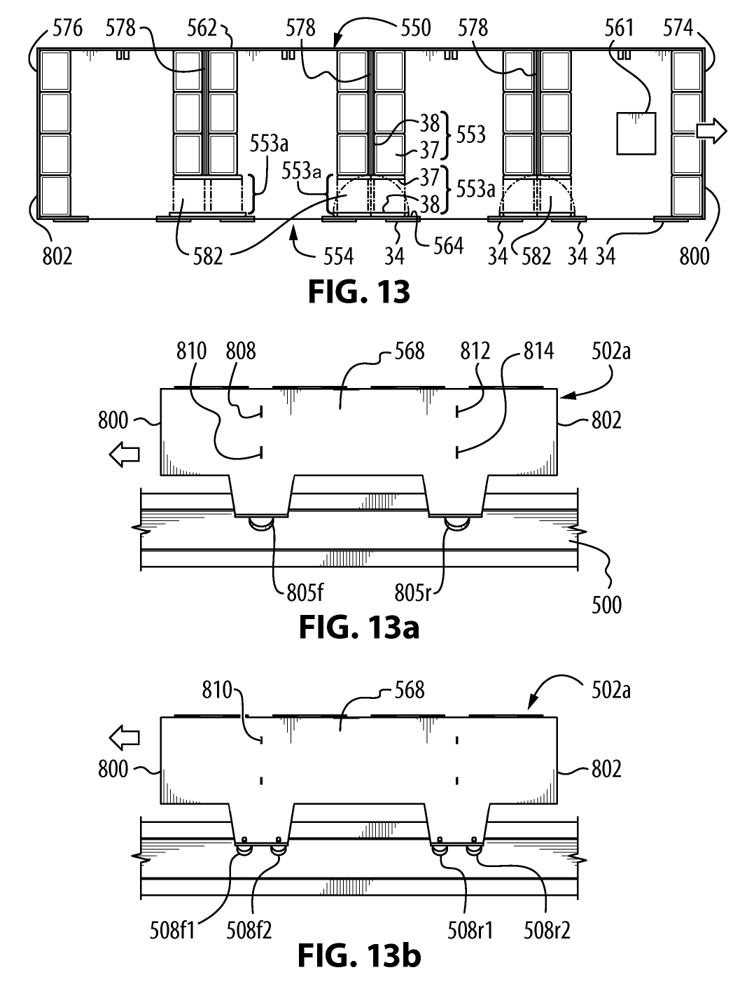

Referring to FIGS. 3 and 13, to permit all the occupants of the vehicle 502a to access the escape hatch 561 to the evacuation slide 32, a passageway may be provided between adjacent cells 556 of seats 553 by making one of the seats 553 foldable in some suitable way. For example, as shown in FIG. 13, a seat 553a that is positioned adjacent the outboard wall, shown at 562 may have a seat portion 37 and a backrest 38 that are separately hingeably connected to adjacent structure.

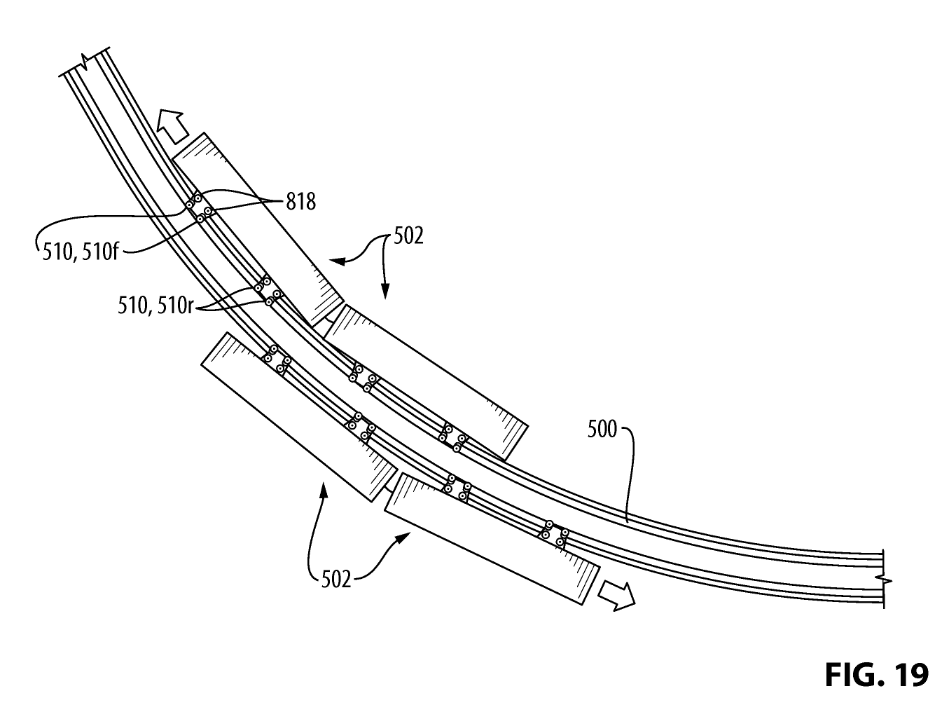

The wheels 508 and 510 of the vehicle 502a may be positioned at any suitable positions along the length of the vehicle 502a. For example, as shown in FIG. 2 and 13, front wheels shown at 508f and 510f may be positioned approximately ¼ of the length of the vehicle 502a from the front end of the vehicle 502a, shown at 800, and rear wheels shown at 508r and 510r may be positioned approximately ¼ of the length of the vehicle 502a from the rear end of the vehicle 502a, shown at 802. For a generally linearly shaped inboard wall 562, the sets of wheels 508 and 510 are thus optimally positioned to permit the vehicle 502a to have the smallest turning radius when turning an inside corner as shown for the vehicle 502i in FIG. 8b, and when turning an outside corner as shown for the vehicle 502o in FIGS. 8b and 19. The upper front wheel 508f in FIG. 2 may be driven by the motor 23.

As shown in FIG. 1b, it is alternatively possible to have a lower wheel 510 be driven by the motor 23. In the embodiment in FIG. 1b, the motor 23 drives the wheel 510 by way of first and second bevel gears 804 and 806. Note that in FIG. 1b, the driven wheel is a front wheel 510f. The rear lower wheel is not shown in FIG. 1b and was omitted from the figure to permit the front wheel 510f and the related drive components to be seen. By driving one of the front wheels 508f or 510f, the vehicle 502 may be less likely to raise any wheels off the guideway 500 during hard acceleration, thereby reducing the likelihood of the vehicle 502 jumping off the guideway 500, relative to an embodiment wherein one of the rear wheels 508r or 510r (FIG. 2) is driven.

As shown in FIG. 1b, the lower front wheel 510f (and the lower rear wheel 510r) could be relatively short and wide, similar to the upper wheels 508 (FIG. 1).

It is possible however for the motor 23 to be used to drive one of the rear wheels 508r or 510r (FIG. 2).

Reference is made to FIG. 13b, which shows a variant of the wheeled vehicle 502a. In the variant shown in FIG. 13b, the vehicle 502a has two front upper wheels 508f, shown individually at 508f1 and 508f2, two rear upper wheels 508r, shown individually at 508r1 and 508r2, and may similarly have two front lower wheels 510f (not shown in FIG. 13b) and two rear lower wheels 510r. Having a pair of wheels at each point (ie. the upper front and back and at the lower front and back) is advantageous in certain embodiments such as embodiments wherein the wheels have pneumatic tires, because it permits the vehicle 502 to continue to roll in the event that one wheel from the pair suffers a puncture or some other damage resulting in a loss of tire pressure. Each wheel and tire in the pair would preferably be designed to support its associated portion of the vehicle alone without the help of the other wheel from the pair, at least temporarily.

The minimum radius of curvature that is negotiable by a train of vehicles 502a depends on several factors including the distance between the front wheels 508f and 510f and the rear wheels 508r and 510r, the spacing between adjacent vehicles 502, the distance that the vehicle 502a is cantilevered outwards from its wheels 508 and 510, the nature of the hinges that join adjacent vehicles 502, and the curvature of the guideway 500.

The vehicle 502a may include a caliper brake 25 that is positioned to clamp the upwardly extending portion 518 of the first flange support member 7a for slowing and stopping the vehicle 502a. The caliper brake 25 may be positioned towards the rear 802 of the vehicle 502a so as to inhibit the vehicle 502a from tipping forward during braking, thereby reducing the risk of one end of the vehicle 502a from leaving the guideway 500, relative to an embodiment wherein the brake 25 would be positioned proximate the front of the vehicle 502. It is nonetheless alternatively possible to position the brake 25 proximate the front.

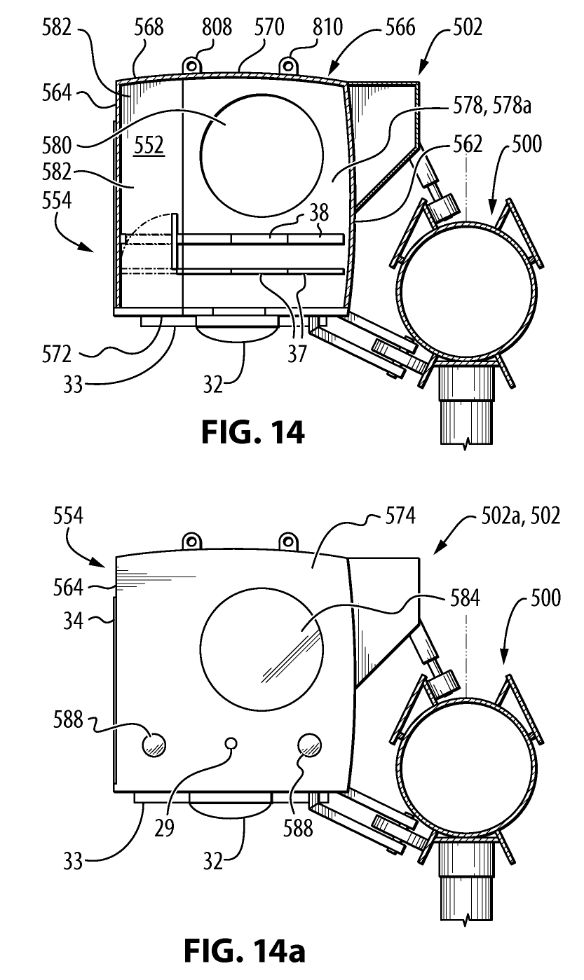

Referring to FIG. 14, the body of the vehicle 502a is shown at 566. The vehicle body 566 may be constructed in any suitable manner. For example, the vehicle body 566 may include a primary shell section 568 that is formed from an integral sheet of material, such as a suitable metal, into a four-sided shape. Thus the integral sheet of material forms the inboard wall 562, the outboard wall 564, the roof, shown at 570, and the floor, shown at 572. Front and rear walls, shown at 574 and 576 respectively in FIG. 13, are welded or otherwise attached to the primary shell section 568 to close the front and rear of the vehicle body 566. Reinforcement walls 578 are positioned inside the primary shell section 568 and connect between the floor 572, the roof 570 and one of the inboard and outboard walls 562 and 564 (preferably the inboard wall 562). In the embodiment shown in FIG. 13, the reinforcement walls 578 connect to the inboard wall 562. Openings, shown at 580 in FIG. 14, may be provided in the reinforcement walls 578 to provide a more open feel to the interior of the passenger compartment 552. Openings 582 are provided between the reinforcement walls 578 and the unconnected wall 562 or 564 to permit passenger access between adjacent cells 556, once the seats 553a are folded out of the way.

As shown in FIGS. 2 and 14a, windows 584 may be provided in the outboard wall 564 and in the front wall 574 (and in the rear wall 576 shown in FIG. 13, though the window is not shown in that figure).

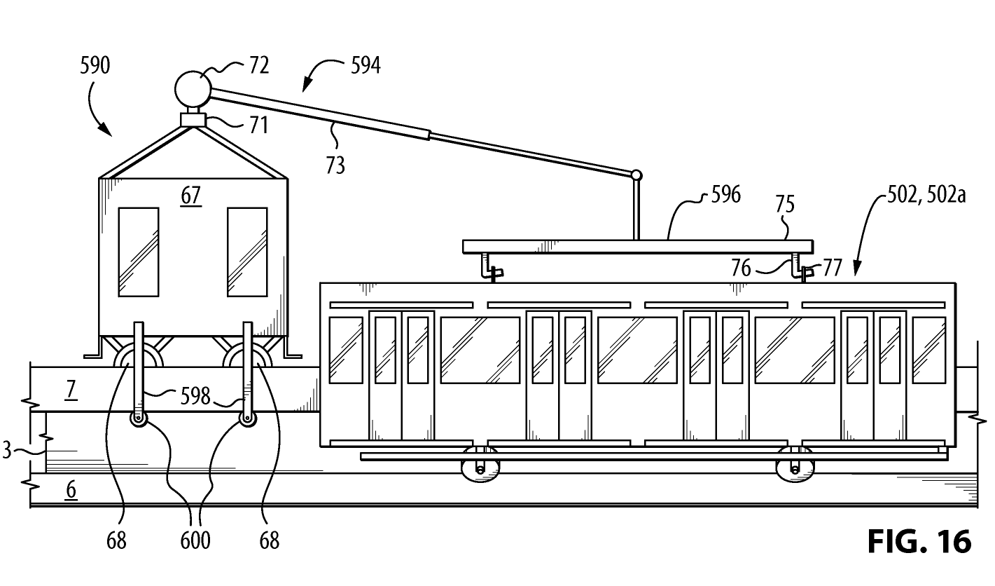

The vehicle 502a may be provided with suitable connectors, shown at 29, at the front and rear for connection to other vehicles 502a so as to form a train. Additionally, headlights 588 (FIG. 14a) and taillights (FIG. 16) may be provided on the vehicle 502a.

The vehicle 502a may be provided with a power pick-up armature 24 (shown in FIG. 1 in relation to the vehicle 502b) which is configured to engage and receive power from the power transfer surface 513a to transfer electrical power from a power source within the guideway 500 to the vehicle 502a.

As shown in FIG. 13a, the vehicle 502a may be provided with pick up ears 808, 810, 812 and 814 which are positioned in alignment with the first and third reinforcement walls 578a and 578c. The pick up ears 808 and 810 are shown in elevation in FIG. 14.

As shown in FIG. 1, the guideway 500 is capable of handling wheeled vehicles 502, such as the vehicle 502a. The guideway 500 may also be capable of handling magnetically levitated vehicles 502, such as the vehicle 502b.

The vehicle 502b may be similar to the vehicle 502a except that the vehicle 502b is magnetically levitated and propelled, instead of using motor-driven wheels. As such, instead of wheels 508 and 510 and a rotational drive system such as an electric motor, the vehicle 502b may include an upper attracting electromagnet 26 that interacts with the flange support member 7c, a lower attracting electromagnet 27 that interacts with the fourth vehicle support flange 6d, and a vertical attracting electromagnet 28 that interacts with the fourth flange support member 7d. The electromagnets 26, 27 and 28 interact with the guideway 500 to hold the vehicle 502b aloft during use. In addition, the vehicle 502b further includes a lineal induction propulsion magnet 30, which interacts with the guideway 500 to propel the vehicle 502b during use. The vehicle 502b may further include a plurality of vehicle supports 29a and 29b which hold the vehicle 502b on the guideway 500 when the electromagnets 26, 27 and 28 are off. Gap sensors (not shown) may be provided at suitable positions eg. at the vehicle supports 29a and 29b, to permit adjustment of the power to the electromagnets 26, 27 and 28 and 30 as necessary to support the vehicle 502b within a selected acceptable range of distances from the guideway 500.

It will be noted that the guideway 500 may be capable of supporting the operation of both wheeled and magnetically levitated vehicles 502a and 502b, and may further be capable of supporting their simultaneous operation. In other words, some of the vehicles 502 operating on the guideway 500 may be magnetically levitated and some vehicles 502 could be wheeled. This permits the owner of the vehicles 502 to upgrade the vehicles 502 individually as they wear out or as finances permit from wheeled vehicles 502a to magnetically levitated vehicles 502b, without requiring a new guideway 500 or acquiring a complete fleet of vehicles at one time.

In the event of a breakdown of a vehicle 502, the vehicle 502 may be removed from the guideway 500 and lowered to the ground by any suitable means. For example, referring to FIG. 2, the vehicle 502 may be provided with forklift sleeves 33 that are configured to receive the forks of a ground-based forklift (not shown). To remove a vehicle 502 from the guideway 500 may simply require disconnection of the power pick-up armature 24 and the caliper brake 25 from the guideway 500 and then lifting the vehicle 502a upwards along a selected path in order to clear the elements of the guideway 500. For magnetically levitated vehicles 502b, the electromagnets 27 and 28 would additionally be movable to a non-engagement position to permit the vehicle 502b to clear the guideway 500.

The vehicle 502 may be provided with feet suitably spaced along the body 566 for supporting the vehicle 502 once it is placed on the ground. Rear feet are shown at 816 and 818 in FIG. 1b.

Referring to FIG. 1b, the walls 562 and 564 and roof 568 of the vehicle 572 may optionally be arcuate, curving outwardly from the center of the vehicle 502. This reduces their likelihood of ‘oil-canning’ (bowing outwardly or inwardly) as a result of stresses incurred during vehicle use.

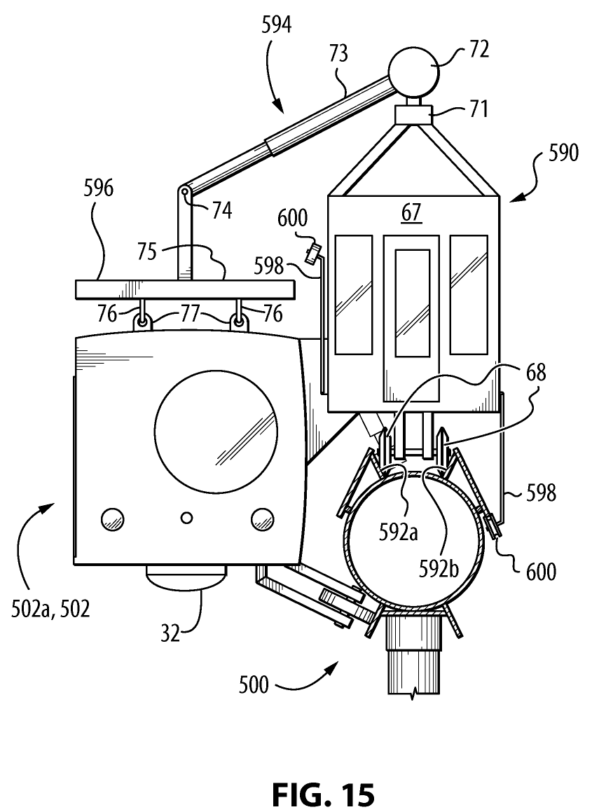

Alternatively or additionally, a mobile crane 590 (shown in FIG. 15) may be provided that can reach the disabled vehicle 502, and remove the disabled vehicle 502 from the guideway 500 and lower it to the ground. The mobile crane 590 may be configured to ride on the top of the guideway 500, engaging the corners shown at 592a and 592b between the track support and the first and third vehicle support flanges 6a and 6c respectively. The wheels of the mobile crane 590, which are shown at 68, may thus be shaped to engage the aforementioned corners on top of the guideway 500. It will be noted that appropriate clearance or accommodation would be made in the wheels 68 for any welds that would be present in the corners 592a and 592b.

The mobile crane 590 includes a cab 67 in which the operator (not shown) can reside and a crane 594. The crane 594 may have any suitable configuration. For example, the crane 594 may include a horizontal rotary joint 71, a vertical rotary joint 72, an extendible boom 73 (eg. a hydraulic ram) that is connected at one end to the vertical rotary joint 72, a universal joint 74 at the other end of the boom 73, and a lifting frame 75 for engaging the vehicle 502. The lifting frame 75 may include a frame portion 596 and a plurality of hooks 76 (eg. four hooks 76) which engage lifting ears 77 provided on the vehicle 502.

The mobile crane 590 may further include a mechanism to brace itself in order to lift the vehicle 502 off the guideway 500. The mechanism may include a pair of gripper arms 598 mounted on each side of the mobile crane 590. The gripper arms 598 may be rotatable from a retracted position shown on the left side of the mobile crane 590 in FIG. 15, to a bracing position shown on the right side of the mobile crane 590 in FIG. 15. In the bracing position, a roller 600 or some other suitable engagement member engages the lower edge of one of the third flange support member 7c. It will be understood that if the gripper arms 598 were lowered on the left side of the mobile crane 590 to facilitate the pick up of a vehicle 502 that was positioned on the right of the mobile crane 590, the gripper arms 598 would engage the lower edge of the first flange member 7a. By engaging the lower edge of the first or third flange support members 7a or 7c, the mobile crane 590 is prevented from tipping over, permitting it to lift the vehicle 502 up off the guideway 500. Once removed from the guideway 500, the rollers 600 facilitate the movement of the mobile crane 590 to a more suitable position if necessary prior to setting the vehicle 502 down on the ground below. A side elevation view of the mobile crane 590 is shown in FIG. 16. It will be noted that, as shown in FIG. 16, the gripper arms 598 may be lowered to their operating positions on both sides of the crane 590 when lifting a vehicle 502. The use of gripper arms 598 eliminates the necessity for a counterbalance weight and a consequent heavier guideway design load.

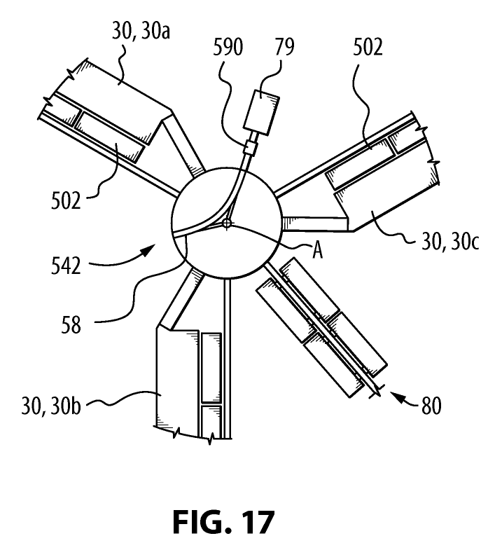

When not in use, the mobile crane 590 may be stored in a suitable storage location shown at 79 in FIG. 17. The turntable switch 542 may be used in an intermediate position, as shown, to provide access to and from the storage location 79. When the mobile crane 590 is needed, the turntable switch 542 would rotate as necessary to permit the mobile crane to enter onto the switch section 58. The turntable switch 542 would then be rotated until the switch section 58 aligned with the desired sections of guideway 500 so that the mobile crane 590 can travel as needed to reach a disabled vehicle 502.

In addition to storing the mobile crane 590 at an intermediate point on the periphery of the turntable switch 542, spare vehicles 502 may be stored in storage locations at one or more intermediate points 80 about the periphery of the turntable switch 542. This would permit the introduction or removal of vehicles 502 into or from use as needed.

Vehicle access platforms shown at 30 in FIG. 3 may be provided to permit passengers to access the vehicles 502. A wall 602 may be provided on the platform 30 to prevent passengers from falling off the platform 30 when vehicles 502 are not present. Platform doors 42 are provided to control access to and from the vehicles 502 onto the platform 30. The vehicles 502 would stop at a selected position so that their doors 34 would align with doors 42 on the vehicle access platform 30.

A vehicle access platform 30 may be arranged to have a separate queuing area 33 and a separate passenger exit passageway 32 for each passenger cell 556 of a vehicle 502. The queuing area 33 may be spaced from the platform doors 42 so as to provide room for passengers to leave the vehicle 502 prior to new passengers entering the vehicle 502. An exit turnstile 604 or the like may be provided to determine how many passengers have left a particular passenger cell 556. An entry turnstile 606 or the like may be provided to control passenger movement out of the queuing area 33 into a particular passenger cell 556. In an embodiment wherein a sufficiently powerful control system is provided for the mass transit system 400, the control system could monitor pass-through of the entry and exit turnstiles 606 and 604 and could control the operation of the entry turnstile 606 to control passenger access to each passenger cell 556 based on its knowledge of how many passengers are already present in each cell 556. Displays shown at 45 may be provided at suitable positions to indicate how many spaces are available in each passenger cell 556 to assist passengers in selecting which queuing area 33 to approach.

A transit station (not shown in FIG. 3) may be provided underneath the guideway 500 at ground level, with elevators, escalators, stairs and/or the like providing access to a vehicle access platform 30 on each side of the guideway 500.

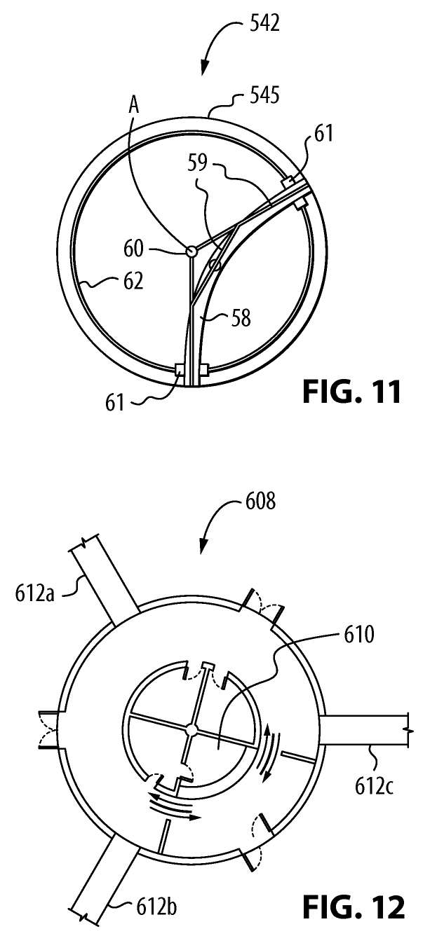

An exemplary transit station is shown at 608 in FIG. 12, which would be positioned underneath a turntable switch 542 and which would provide passenger access to three vehicle access platforms 30a, 30b and 30c (FIG. 10a, 10b or 10c). The transit station 608 provides a ticket booth 610 and controlled access to escalators 612a, 612b and 612c to the platforms 30a, 30b and 30c respectively.

The mass transit system 400 may include a control system 614 (shown in FIG. 1). The control system 614 may be configured to read input from vehicle position sensors 616 (FIG. 10a) on the guideway 500. The sensors 616 may be equipped to read bar codes (not shown) or other identifying indicia on the vehicles 502 so that the control system 614 can track the specific position, and optionally the speed, of each individual vehicle 502. Each vehicle 502 may be provided with a copy of the bar code or other indicia on both the front and rear and the sensors 616 could be equipped to read both the front and rear of the vehicles 502 so as to provide redundancy in the reading operation to assist in reducing errors in readings from the sensors 616. Additionally, the control system 614 can determine the velocity of the vehicles 502 by measuring the time interval between reading the bar code at the front of the vehicle 502 and reading the bar code at the rear.

As described above, the control system 614 may receive input from sensors in the entry and exit turnstiles 606 and 604 to determine the number of passengers in each passenger cell 556 (FIG. 3).

The control system 614 can be used for implementing a distance-based fee structure for the mass transit system 400. For example, a passenger may swipe a card through a card-reader upon entry into the queuing area 33 (FIG. 3) or upon passage through the entry turnstile 606 and may swipe the card through a card-reader at some point after exiting the vehicle 502, eg. at the exit turnstile.

Suitable sensors 56 (FIG. 1) may be provided at selected positions about the periphery of the guideway 500 to determine if any obstructions (such as animals or persons that have climbed onto the guideway 500) are present on the guideway 500. The sensors 56 may be any suitable types of sensors, such as sensors using laser beam emitters.

Each vehicle 502 may also include a control system, shown at 618 in FIG. 1) for controlling the operation of selected elements of the vehicle 502. The control system 618, may, for example, control the operation of the vehicle doors 34 to ensure that they do not open unless they are suitably interlocked with the doors 42 (FIG. 3) at the vehicle access platform 30. The control system 618 may control the operation of the caliper brake 25, so that, for example, the brake 25 is engaged with the guideway 500 when power is off to the vehicle 502 and at selected times during deceleration of the vehicle 502. In this way, the control system 614 would be able to track the distance traveled by the passenger. Payment could take place in any suitable way. For example, the passenger could be obligated to pay a maximum fee initially and could be refunded whatever amount is suitable after swiping their card upon exiting from the vehicle 502.

In the above description and drawings caliper brakes 25 have been described for stopping the vehicle 502. It is alternatively possible, however, to provide a regenerative braking system that could convert the vehicle's kinetic energy into electrical energy. It is further possible that some or all of the electrical energy could be metered back to a power source through electrical conduits associated with the guideway 500. This would be suitable for linear induction propulsion systems, which can be used for both wheeled and magnetically levitated vehicles 502.

In the embodiments described and shown, the configuration of the guideway 500 is such that it forms a valley with its upper surfaces, which can collect precipitation (eg. rain, snow). To prevent the accumulation of prepitation in the valley, drains may be provided at regular intervals along its length. The drains may be connected to downpipes (not shown) to transport the precipitation down to ground level in a controlled manner. The downpipes may, for example, be mounted along the sides of the columns 526 (FIG. 2).

While the above description constitutes a plurality of embodiments of the present invention, it will be appreciated that the present invention is susceptible to further modification and change without departing from the fair meaning of the accompanying claims.

1. A guideway for a vehicle, wherein the a vehicle has a center of mass, comprising:
a track support, wherein the track support is cylindrical and hollow;
a first vehicle support flange connected to the track support at a first elevation; and
a second vehicle support flange connected to the track support at a second elevation that is different than the first elevation,
wherein the first and second vehicle support flanges are configured to support the vehicle on one side of the center of mass.

2. A guideway as claimed in claim 1, further comprising a plurality of columns for supporting the guideway sufficiently high to permit vehicular traffic to pass underneath the vehicle.

3. A guideway as claimed in claim 1, wherein the first and second vehicle support flanges extend radially from the track support.

4. A guideway as claimed in claim 1, further comprising a flange support member, wherein the flange support member, one of the first and second vehicle support flanges and an associated portion of the track support generally form a triangle in cross-section.

5. A guideway as claimed in claim 1, wherein each of the first and second vehicle support flanges is supported by an associated flange support member such that each of the vehicle support flanges, the associated flange support member and an associated portion of the track support generally form a triangle in cross-section.

6. A guideway as claimed in claim 1, wherein the vehicle is a first vehicle and wherein the first and second vehicle support flanges are configured to support the first vehicle on a first side of the track support and wherein the guideway further comprises a third vehicle support flange connected to the track support at a third elevation, and a fourth vehicle support flange connected to the track support at a fourth elevation that is different than the third elevation, wherein the third and fourth vehicle support flanges are configured to support a second vehicle on a second side of the track support that is opposed to the first side.

7. A guideway as claimed in claim 1, wherein the third and fourth vehicle support flanges and the first and second vehicle support flanges are symmetrical about a vertical plane that bisects the track support longitudinally.

8. A guideway as claimed in claim 1, further comprising a power transfer surface that is connectable to a power source associated with the track support, wherein the power transfer surface is configured to carry electrical power to the vehicle.

9. A guideway as claimed in claim 8, wherein the power transfer surface is positioned within a downwardly facing recess.

10. A guideway for a vehicle, wherein the vehicle has a center of mass, comprising:
a track support, wherein the track support is cylindrical and hollow;
a first vehicle support flange connected to the track support; and
a second vehicle support flange connected to the track support,
wherein the first and second vehicle support flanges are configured to support the vehicle with on one side of the center of mass.

11. A mass transit system, comprising:
a vehicle having a center of mass;
a track support, wherein the track support is cylindrical and hollow;
a first vehicle support flange connected to the track support at a first elevation; and
a second vehicle support flange connected to the track support at a second elevation that is different than the first elevation,
wherein the first and second vehicle support flanges are configured to support the vehicle on one side of the center of mass.

12. A mass transit system as claimed in claim 11, further comprising a plurality of columns for supporting the guideway sufficiently high to permit vehicular traffic to pass underneath the vehicle.

13. A mass transit system as claimed in claim 11, wherein the first and second vehicle support flanges extend radially from the track support.

14. A mass transit system as claimed in claim 11, further comprising a flange support member, wherein the flange support member, one of the first and second vehicle support flanges and an associated portion of the track support generally form a triangle in cross-section.

15. A mass transit system as claimed in claim 11, wherein each of the first and second vehicle support flanges is supported by an associated flange support member such that each of the first and second vehicle support flanges, the associated flange support member and an associated portion of the track support generally form a triangle in cross-section.

16. A mass transit system as claimed in claim 11, wherein the vehicle is a first vehicle and wherein the first and second vehicle support flanges are configured to support the first vehicle on a first side of the track support and wherein the guideway further comprises a third vehicle support flange connected to the track support at a third elevation; and
a fourth vehicle support flange connected to the track support at a fourth elevation that is different than the third elevation, wherein the third and fourth vehicle support flanges are configured to support a second vehicle on a second side of the track support that is opposed to the first side.

17. A mass transit system as claimed in claim 11, wherein the third and fourth vehicle support flanges and the first and second vehicle support flanges are symmetrical about a vertical plane that bisects the track support longitudinally.

18. A mass transit system as claimed in claim 11, wherein the guideway further includes a power transfer surface that is connectable to a power source associated with the track support, wherein the power transfer surface is configured to carry electrical power to the vehicle.

19. A mass transit system as claimed in claim 18, wherein the power transfer surface is positioned within a downwardly facing recess.

20. A mass transit system as claimed in claim 11, wherein the vehicle is a wheeled vehicle.

21. A mass transit system as claimed in claim 11, wherein the vehicle is a magnetically levitated vehicle.
